(19) United States
(12) Patent Application Publication
(10) Pub. No.: US 2021/0011568 A1
(43) Pub. Date: Jan. 14, 2021

(54) ELECTRONIC DEVICE WITH FINGERPRINT IDENTIFICATION MECHANISM

(71) Applicant: Newmax Technology Co., Ltd., Taichung City (TW)

(72) Inventors: Kuo-Fu Fan, Taichung City (TW); Hung-Ta Chen, Taichung City (TW); Tsung-Chi Tsai, Taichung City (TW)

(21) Appl. No.: 16/507,650

(22) Filed: Jul. 10, 2019

(51) Int. Cl. G06F 3/042; G06F 3/0488; G06K 9/00; H04N 5/247

(52) U.S. Cl. CPC G06F 3/042; H04N 5/247; G06K 9/00013; G06F 3/0488

(57) ABSTRACT

An electronic device with fingerprint identification mechanism includes a touch panel, a camera unit, and a processing unit. A part of the touch panel is defined as a recognition area. The touch panel is adapted for at least one finger to touch for controlling. The camera unit is arranged under the touch panel. The camera unit includes a plurality of camera devices spacedly arranged. The camera devices face the touch panel. Projections of imaging ranges of the camera devices on the touch panel partially overlap so that the recognition area is covered by the projections of the imaging ranges of the camera devices. The processing unit is electrically connected to the touch panel and the camera unit respectively.

### BACKGROUND OF THE INVENTION

### Field of the Invention

The present invention relates to an electronic device with fingerprint identification mechanism.

### Description of the Prior Art

A mobile electronic device such as tablet or smartphone usually uses a fingerprint recognition mechanism for unlocking the device. A normal fingerprint recognition mechanism shown in TW I409707 has a fingerprint recognition area outside the touch panel (e.g. beside the touch panel or at the rear side of the electronic device). A camera is arranged under the finger recognition area to capture images of the finger. However, the imaging area of the camera is limited, so the size of the recognition area is not much bigger than the area of fingerprint. Thus, the user has to press his finger exactly on the small recognition area to complete recognition. However, this structure is not quite inconvenient for the user. Because the recognition area has an appearance different from other areas, the user can easily find the recognition area out and press his finger.

Another type of recognition area is arranged as a part of the touch panel. The camera is arranged under the touch panel. The user presses his finger on a specific area on the touch panel for recognition. However, as mentioned above, the recognition area is quite small, and the recognition area is difficult to identify. Thus, the user is difficult to complete recognition in a single press. On the contrary, the user may press the area outside the recognition area, so the user has to try several times.

### SUMMARY OF THE INVENTION

The main object of the present invention is to provide an electronic device with fingerprint identification mechanism having a wider fingerprint recognition area to make fingerprint recognition easier.

To achieve the above and other objects, an electronic device with fingerprint identification mechanism includes a touch panel, a camera unit, and a processing unit.

A part of the touch panel is defined as a recognition area. The touch panel is adapted for at least one finger to touch for controlling. The camera unit is arranged under the touch panel. The camera unit includes a plurality of camera devices spacedly arranged. The camera devices face the touch panel. Projections of imaging ranges of the camera devices on the touch panel partially overlap so that the recognition area is covered by the projections of the imaging ranges of the camera devices. The processing unit is electrically connected to the touch panel and the camera unit respectively.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a top view of the present invention;

FIG. 2 is a top view showing a camera unit of the present invention;

FIG. 3 to FIG. 5 are top views showing a camera unit in other embodiments of the present invention;

FIG. 6 is a partial lateral view of the present invention;

FIG. 7 is a partial lateral view showing another embodiment of the present invention.

### DETAILED DESCRIPTION OF THE PREFERRED EMBODIMENTS

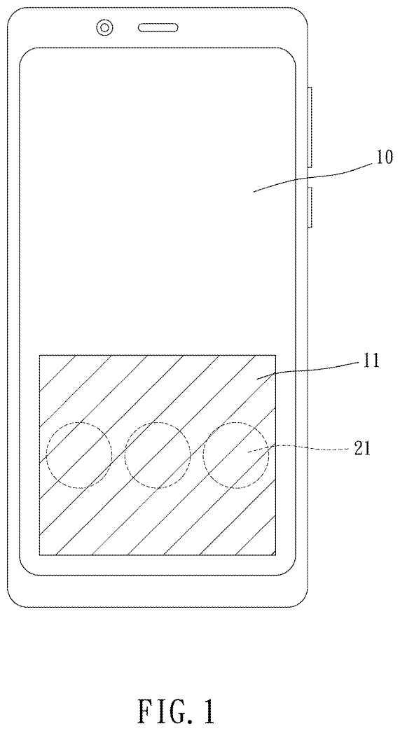

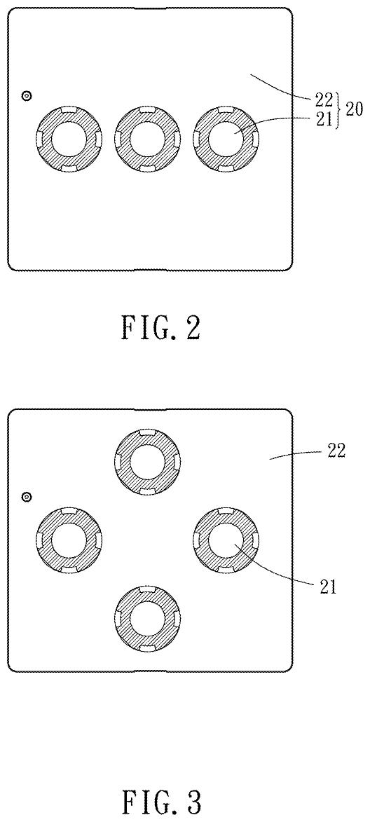

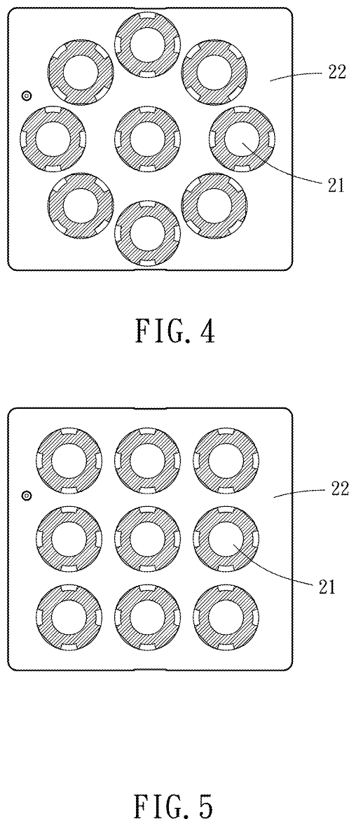

Please refer to FIG. 1 to FIG. 6, the electronic device with fingerprint identification mechanism includes a touch panel 10, a camera unit 20, and a processing unit.

A part of the touch panel 10 is defined as a recognition area 11. The touch panel 10 is adapted for at least one finger to touch for controlling. The camera unit 20 is arranged under the touch panel 10. The camera unit 20 includes a plurality of camera devices 21 spacedly arranged. The camera devices 21 face the touch panel 10. Projections of imaging ranges of the camera devices 21 on the touch panel 10 partially overlap so that the recognition area 11 is covered by the projections of the imaging ranges of the camera devices 21. The processing unit is electrically connected to the touch panel 10 and the camera unit 20 respectively.

In the present embodiment, the recognition area 11 is more than twice a finger-pressing area. Thereby, the fingerprint can be successfully recognized no matter where the finger presses. In addition, the camera unit 20 further includes a mount 22. The camera devices 21 are disposed on the mount 22. Preferably, a longitudinal direction and a horizontal direction perpendicular to each other are defined both parallel to a surface of the touch panel 10, and the camera unit 20 includes a plurality of said camera devices 21 along both the longitudinal direction and the horizontal direction, as shown in FIG. 3 to FIG. 5. The number of the camera devices 21 can be alternated according to the size of the recognition area 11 or the imaging range of the camera device 21.

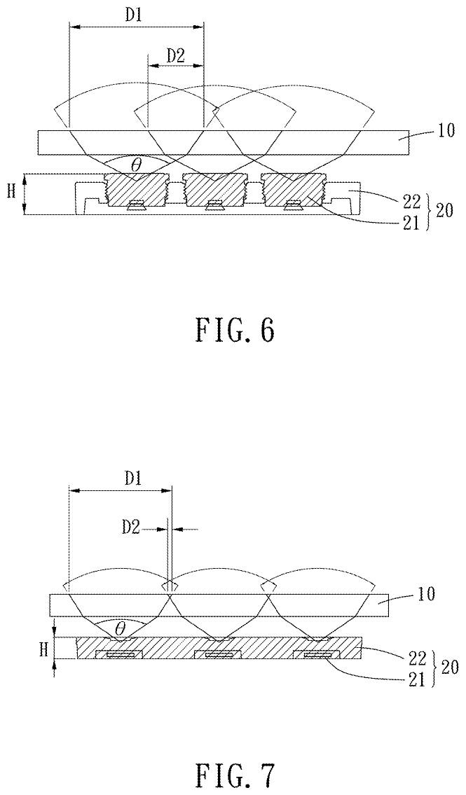

In the present embodiment in FIG. 6, each of the camera devices 21 is a independent device composed of a lens mount and lenses therein. However, in the embodiment in FIG. 7, each of the camera devices 21 can only include the lenses, and the mount 22 is formed with some receiving spaces similar to the lens mount for receiving the lenses. The total height H of the camera device 21 and the mount 22 is smaller than or equal to 1.0 mm to make the camera unit thinner.

In the preferred embodiment, when observing from a lateral side of each of the camera devices 21, an angle θ between borders at two sides of the imaging area of the camera device 21 is ranged between 110-130 degrees. Besides, the projection of the imaging range of each of the camera devices 21 on the touch panel 10 has a diameter defined as D1. When observing from a lateral side of any two adjacent ones of the camera devices 21, a width of an overlap area of the projections of the imaging ranges of the two camera devices 21 on the touch panel 10 is defined as D2. D2 is equal to or more than 0.3 time D1. Preferably, D2 is equal to or more than 0.4 time D1.

In conclusion, the present invention provides a larger recognition area for fingerprint recognition. Because the recognition area is completely covered by the imaging ranges of the camera devices, fingerprint recognition can be done no matter where the user presses his finger. Thus, fingerprint recognition becomes quicker and easier.

Specifically, in contrast to rear-mounted fingerprint scanner, touch panel is much wider than the finger, and the recognition area has no identify marks. The user can only know a rough range of recognition. Conventional recognition scanner only has a single camera device to have a quite small recognition area. The user perhaps has to press his finger several times until the recognition completed.

The present invention allows the user to complete the recognition within minimum presses to improve the efficiency.

1. An electronic device with fingerprint identification mechanism, including:
a touch panel, a part of the touch panel being defined as a recognition area, the touch panel being adapted for at least one finger to touch for controlling;
a camera unit, arranged under the touch panel, the camera unit including a plurality of camera devices spacedly arranged, the camera devices facing the touch panel, projections of imaging ranges of the camera devices on the touch panel partially overlapping so that the recognition area is covered by the projections of the imaging ranges of the camera devices;
a processing unit, electrically connected to the touch panel and the camera unit respectively.

2. The electronic device with fingerprint identification mechanism of claim 1, wherein the recognition area is more than twice a finger-pressing area.

3. The electronic device with fingerprint identification mechanism of claim 1, wherein the camera unit further includes a mount, the camera devices are disposed on the mount.

4. The electronic device with fingerprint identification mechanism of claim 1, wherein when observing from a lateral side of each of the camera devices, an angle between borders at two sides of the imaging area of the camera device is ranged between 110-130 degrees.

5. The electronic device with fingerprint identification mechanism of claim 1, wherein the projection of the imaging range of each of the camera devices on the touch panel has a diameter; when observing from a lateral side of any two adjacent ones of the camera devices, a width of an overlap area of the projections of the imaging ranges of the two camera devices on the touch panel is equal to or more than 0.3 times the diameter of the projection of the imaging range of each of the camera devices on the touch panel.

6. The electronic device with fingerprint identification mechanism of claim 5, wherein the width of the overlap area of the projections of the imaging ranges of the two camera devices on the touch panel is equal to or more than 0.4 times the diameter of the projection of the imaging range of each of the camera devices on the touch panel.

7. The electronic device with fingerprint identification mechanism of claim 1, wherein a longitudinal direction and a horizontal direction perpendicular to each other are defined both parallel to a surface of the touch panel, the camera unit includes a plurality of said camera devices along both the longitudinal direction and the horizontal direction.

8. The electronic device with fingerprint identification mechanism of claim 3, wherein a total height of the mount and the camera device is smaller than or equal to 1.0 mm.
